(19) United States
(12) Patent Application Publication
(10) Pub. No.: US 2009/0129501 A1
(43) Pub. Date: May 21, 2009

(54) Optimal signaling and selection verification for transmit antenna selection with erroneous feedback

(76) Inventors: Neelesh B. Mehta, Secunderabad (IN); Yabo Li, San Jose, CA (US); Andreas F. Molisch, Arlington, MA (US); Jinyun Zhang, Cambridge, MA (US)

Correspondence Address: MITSUBISHI ELECTRIC RESEARCH LABORATORIES, INC., 201 BROADWAY, 8TH FLOOR, CAMBRIDGE, MA, 02139, US

(21) Appl. No.: 11/990,650

(22) PCT Filed: Aug. 19, 2005
(86) PCT No.: PCT/US05/29746

§ 371 Date: Feb. 19, 2008

(51) Int. Cl. H04L 27/00

(52) U.S. Cl. 375/299

(57) ABSTRACT

A method is provided for receiving data at a receiver via a communication channel from a transmitter having at least two transmitter antennas, the method including: receiving (S204) a codebook including an assignment of at least two respective codewords to the at least two transmitter antennas, the assignment being based at least in part on a characteristic of the communication channel; detecting a state of the communication channel by which the receiver can communicate with the transmitter; selecting (S206) at least one desired transmitter antenna from the at least two antennas based at least in part on the detected state of the communication channel; transmitting (S208) to the transmitter a codeword corresponding to the at least one desired transmitter antenna; and receiving (S210) data at the receiver transmitted by the transmitter.

### BACKGROUND OF THE INVENTION

1. Field of the Invention

The present invention relates generally to methods, devices, and systems to select a transmit antenna by accounting for errors in feedback from a receiver. The present invention also relates to methods, devices, and systems to identify the transmit antenna at a receiver.

2. Discussion of the Background

While multiple-input multiple-output (MIMO) systems may yield remarkable improvements in both data transmission rates and the reliability of transmission over wireless channels without requiring any additional bandwidth, their widespread adoption has been inhibited by issues such as increased hardware and signal processing complexity. This is because each transmit antenna requires a dedicated radio frequency (RF) chain that includes a digital-to-analog (D/A) converter, a frequency-up converter, and a power amplifier. At the same time, each receive antenna requires an RF chain that comprises a low noise amplifier (LNA), a frequency-down converter and an analog-to-digital (AID) converter.

Generally speaking, antenna selection is a low-complexity technique that reduces the hardware complexity of MIMO systems. A selection switch enables the use of a subset of the available antennas for data transmission or reception. Therefore, fewer RF chains than the total number of available antennas are required. Even so, it has been shown that under ideal conditions antenna selection can achieve the full diversity order of the wireless channel in several systems.

Receive antenna selection (RAS) has been studied in single input multiple output systems (SIMO) and for MIMO channels. Transmit antenna selection (TAS) has also received more attention recently. For lower-rank wireless channels, TAS may increase the data transmission rate compared to the transmitters that do not have access to channel state information (CSI).

Feedback from a receiver is useful when implementing TAS, as the CSI is often not readily available at the transmitter. This is because the short-term fading in the forward and reverse channels is typically uncorrelated in frequency division duplex systems (FDD) systems. Even in time division duplex (TDD) systems, in which the transmitter can infer the channel state from reverse link transmissions, the CSI may be unreliable at higher Doppler frequencies, or when the forward and reverse link interferences are asymmetric. To minimize overhead, the receiver generally does not feed back the entire channel state. Rather, the receiver determines and feeds back the indices of the antennas that the transmitter should select (e.g., the receiver feeds back a codeword that can be mapped to the antennas to be selected). To optimize overall system performance, the bit rate allowed on the feedback channel and the complexity of the signal is typically severely limited. For example, in third generation (3G) cellular telephone systems, the feedback is uncoded and the bit rate is just 1.5 kbps. Therefore, bit error rates of the feedback can be as high as 4%. While error correction coding can be used to reduce this error rate, the extra bits required for error correction increase the feedback latency and significantly reduce the maximum Doppler frequency that the system can handle.

In the prior art, techniques for antenna selection have often assumed that feedback is error-free and instantaneous. Additionally, those techniques have assumed that the communication channels are uncorrelated. The inventors of the present invention have determined that these assumptions are not always accurate.

### SUMMARY OF THE INVENTION

In light of these difficulties, the Applicants developed the present invention. To this end, a non-limiting aspect of the present invention provides a method for receiving data at a receiver via a communication channel from a transmitter having at least two transmitter antennas, the method including: receiving a codebook including an assignment of at least two respective codewords to the at least two transmitter antennas, the assignment being based at least in part on a characteristic of the communication channel; detecting a state of the communication channel by which the transmitter can transmit to the receiver; selecting at least one desired transmitter antenna from the at least two antennas based at least in part on the detected state of the communication channel; transmitting to the transmitter a codeword corresponding to the at least one desired transmitter antenna; and receiving data at the receiver transmitted by the transmitter.

Another non-limiting aspect of the present invention includes a method performed in a system in which a transmitter transmits data to a receiver using at least one of at least two transmitter antennas and a communication channel, the method including: determining a correlation between a first antenna element of the at least two transmitter antennas, which is assigned a first codeword, and a second antenna element of the at least two transmitter antennas; and assigning a second codeword to the second antenna element based at least in part on a Hamming distance between a first bit sequence representing the first codeword and a second bit sequence representing the second codeword and at least in part on the determined correlation.

The present invention also includes, as a non-limiting embodiment, a method for transmitting data in a system in which a transmitter having at least two transmitter antennas transmits data to a receiver via a communication channel using at least one of the at least two antennas, the method including: transmitting to a receiver a codebook which includes an assignment of at least two respective codewords to at least two of the at least two transmitter antennas, the assignment being based at least in part on a characteristic of the communication channel; receiving at the transmitter a codeword corresponding to at least one desired transmitter antenna; and transmitting data to the receiver using at least one actual transmitter antenna corresponding to the received codeword.

The present invention also provides as another non-limiting aspect a system in which a transmitter having at least two transmitter antennas transmits data to a receiver via a communication channel using at least one of the at least two transmitter antennas, the system including: the transmitter configured to transmit a codebook which includes an assignment of at least two respective codewords to at least two of the at least two transmitter antennas, the assignment being based at least in part on a characteristic of the communication channel; the receiver configured to receive the codebook, to select a codeword corresponding to at least one desired transmitter antenna, and to transmit the selected codeword to the transmitter; and the transmitter further configured to transmit data to the receiver using at least one actual transmitter antenna corresponding to the codeword received at the transmitter from the receiver.

Yet another non-limiting aspect of the present invention provides a computer program product storing a computer program which when executed by a processor in a radio network causes the processor to perform steps of: receiving a codebook including an assignment of at least two respective codewords to at least two transmitter antennas, the assignment being based at least in part on a characteristic of a communication channel; detecting a state of the communication channel by which a receiver can communicate with the transmitter; selecting at least one desired transmitter antenna from the at least two antennas based at least in part on the detected state of the communication channel; transmitting to the transmitter a codeword corresponding to the at least one desired transmitter antenna; and receiving data at the receiver transmitted by the transmitter.

Another non-limiting aspect of the present invention includes a computer program product storing a computer program which when executed by a processor in a radio network causes the processor to perform steps of: determining a correlation between a first antenna element of at least two transmitter antennas, which is assigned a first codeword, and a second antenna element of the at least two transmitter antennas; and assigning a second codeword to the second antenna element based at least in part on a Hamming distance between a first bit sequence representing the first codeword and a second bit sequence representing the second codeword and at least in part on the determined correlation.

Still further, the present invention includes, as a non-limiting aspect, a computer program product storing a computer program which when executed by a processor in a radio network causes the processor to perform steps of: transmitting to a receiver a codebook which includes an assignment of at least two respective codewords to at least two transmitter antennas, the assignment being based at least in part on a characteristic of the communication channel; receiving at the transmitter a codeword corresponding to at least one desired transmitter antenna; and transmitting data to the receiver using at least one actual transmitter antenna corresponding to the received codeword.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a block diagram of a non-limiting example of a system model according to the present invention;

FIG. 2 is a graph of symbol error probability for signaling assignments;

FIG. 3(a) is a scatter plot of the simulated Pₑ(γ, μ) and the metric Mᵥₑᵣ(μ; γ),

FIG. 3(b) is a scatter plot of the average SEP from simulations and the metric Mₙₒ₋ᵥₑᵣ(μ; γ), defined in (27), for no-selection verification;

FIG. 4(a) is a graph comparing the SEP performance of μᵥₑᵣ* and μₙₒ₋ᵥₑᵣ*;

FIG. 4(b) is a graph comparing the performance of the different signaling assignments for different number of receive antennas for Nₜ=16;

FIG. 5(a) is a graph comparing SEP performance of the blind optimal symbol-level selection verification receiver (line) and the blind suboptimal symbol-level selection verification receiver (dot) for the two signaling assignments μᵥₑᵣ* and μₙₒ₋ᵥₑᵣ*;

FIG. 5(b) is a graph of Pᵥₑᵣ^{(T)} and Pᵥₑᵣ^{(R)} using the signaling assignment μᵥₑᵣ*;

FIGS. 6(a) and 6(b) are graphs comparing the average SEP and Pᵥₑᵣ^{(T)} of symbol-level and block-level detection;

FIGS. 7(a) and 7(b) are graphs comparing the SEP and P_{(T)ver} of non-blind optimal selection verification with ideal selection verification and no-selection verification for Nₜ=8, Lₜ=1, and Nᵣ=1;

FIGS. 8(a) and 8(b) are graphs of non-blind optical antenna selection verification as a function of α with μᵥₑᵣ* as the signaling assignment;

FIG. 9 is a table of non-limiting signaling assignments according to one aspect of the present invention;

FIG. 10 is a flow diagram of a non-limiting method of communication in a network according to one aspect of the present invention;

FIG. 11 is a flow diagram of a non-limiting method of a non-limiting example of antenna verification according to one aspect of the present invention;

FIG. 12 is a flow diagram of a non-limiting method of system communications according to one aspect of the present invention; and

FIG. 13 is a flow diagram of another non-limiting example of system communications according to one aspect of the present invention.

### DESCRIPTION OF THE EMBODIMENTS

By way of example in the following explanation of non-limiting aspects of the present invention, the symbol (.)^{T} denotes a matrix transpose, (.)^{†} a Hermitian transpose, ∥.∥ a norm of a vector, and ∥.∥_{F} a Frobenious norm. The symbol C^{a×b} denotes a set of a×b complex matrices. E_{A|B} [.] denotes an expectation over a random variable (RV) A given B. Pr(A|B) denotes a conditional probability of A given B if A is a discrete RV, and p(A|B) denotes a probability distribution function (pdf) of A given B if A is a continuous RV.

FIG. 10 provides a non-limiting illustration of a method of communicating in a network according to the present invention. To this end, step S200 includes mapping codewords to subsets of antennas, thereby constructing a codebook. The subsets of antennas include one or more antennas. In step S202, a transmitter transmits the codebook to a receiver. Generally, this step is performed only upon initialization of the system or at system updates. In step S204, the receiver receives the codebook, and the receiver selects a desired antenna subset in step S206. The desired antenna(s) selected by the receiver may depend upon detected channel state information, as described below.

In step S208 of FIG. 10, the receiver feeds back the codeword to the transmitter using the codebook. Based on the codeword the transmitter receives, the transmitter transmits data to the receiver in step S210. In step S212, the receiver may verify the antenna(s) used by the transmitter. Step 212 is optional depending on a design of the receiver. For more complex receivers, step S212 is performed, while for less complex receivers, the receivers may assume that the transmitter automatically used the selected antenna(s). In other words, less complex receivers cannot account for errors in the feedback.

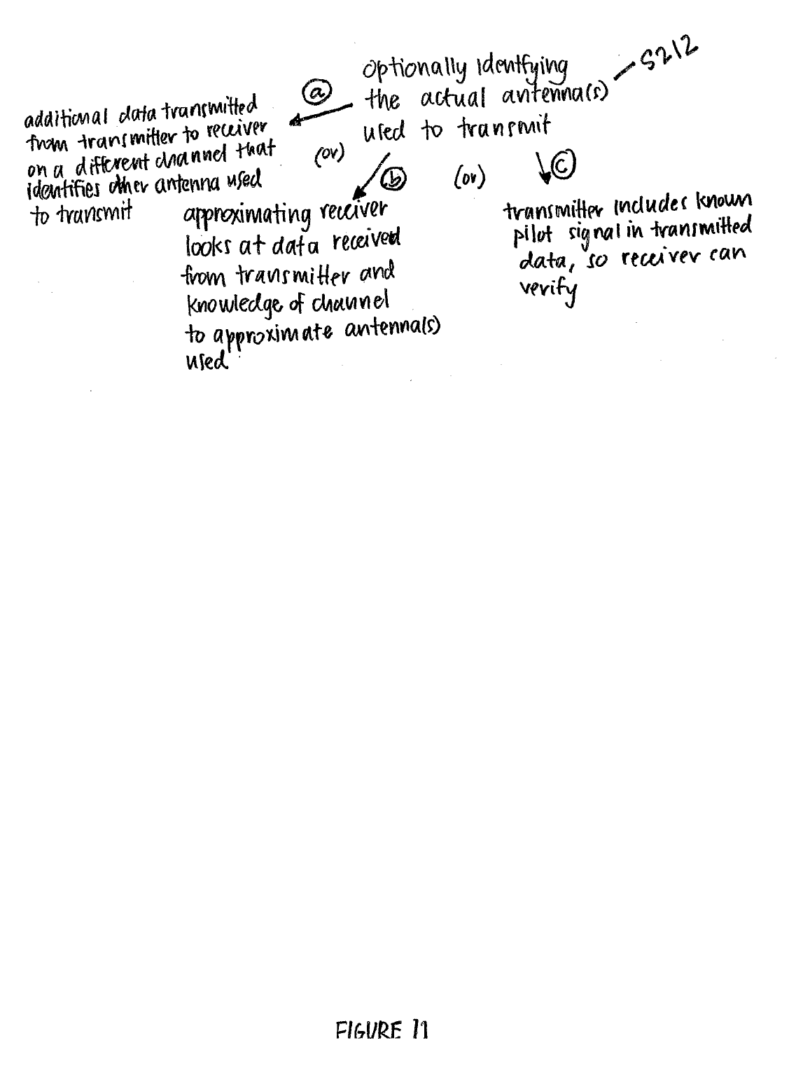

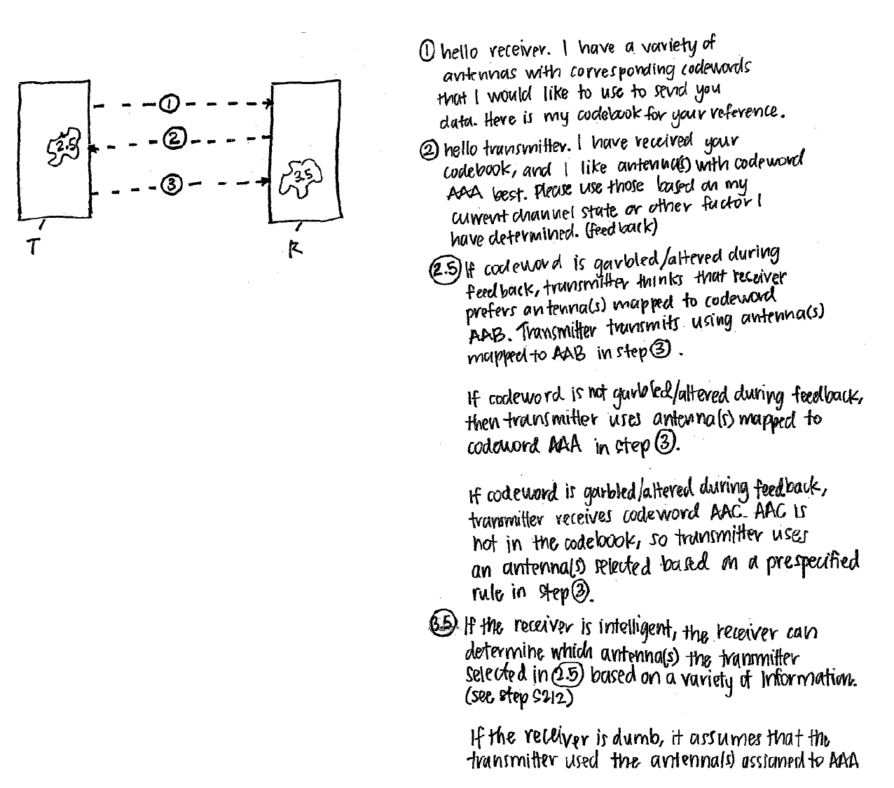

As illustrated in FIG. 11, step S212 may include using additional data transmitted from the transmitter to the receiver on a different channel that identifies the antenna(s) selected in the primary transmission. Alternatively, the receiver may use the data received in the primary transmission and the channel state information to approximate the antenna(s) selected by the transmitter. The receiver may also use a pilot signal embedded in the primary transmission by the transmitter to identify the antenna(s) used to send the data.

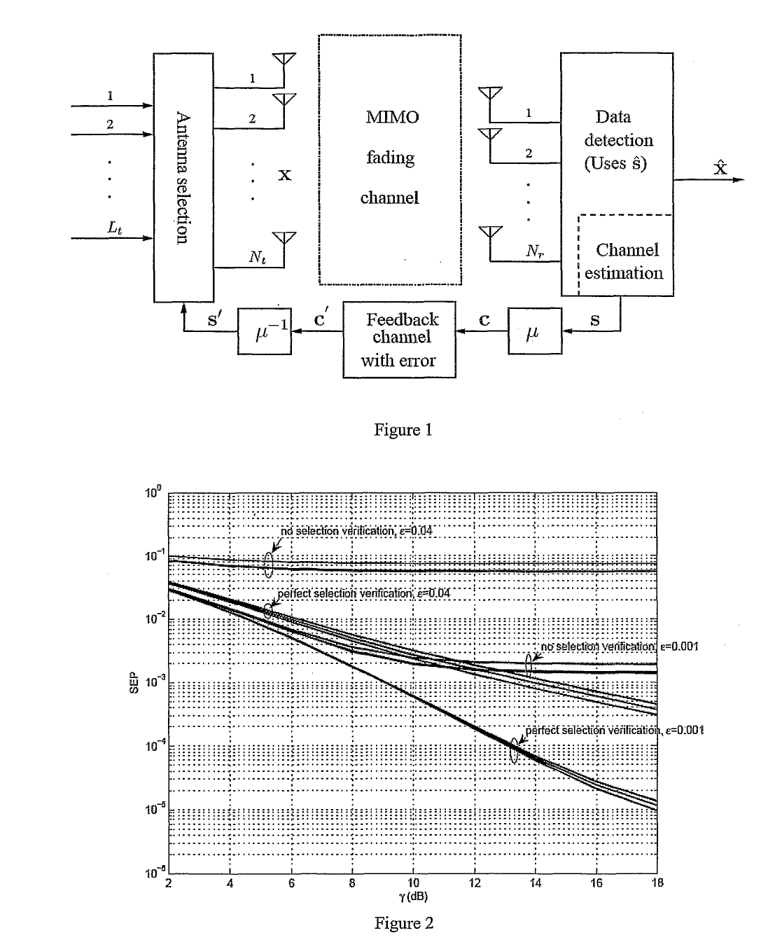

FIG. 1 illustrates a non-limiting example of a system model according to one aspect of the present invention that is capable of performing the method illustrated in FIGS. 10-13. From Nₜ transmit antennas, Lₜ antennas are selected to transmit. There are Nᵣ antennas at the receiver. A received signal vector, yΔ[y₁, y₂, . . . , y_{N}_{ᵣ}]^{T} εC^{N}^{ᵣ}^{x1}, can be written as:

y=Hx+w, (1)

where xΔ[x₁, x₂, . . . , x_{L}_{ₜ}]^{T} εC^{L}^{ₜ}^{x1} is the vector of transmitted signal with QPSK symbols. In (1), wΔ[w₁, w₂, . . . , w_{N}_{ᵣ}]^{T} εC^{N}^{ᵣ}^{x1} is additive white complex Gaussian noise (AWCGN). Without loss of generality, each of elements of the noise is assumed to have unit variance. A matrix H εC^{N}^{ᵣ}^{xL}^{ₜ}, includes coefficients of the channel between the transmitter and the receiver. During transmit antenna selection, the matrix H is an Nᵣ×Lₜ sub-matrix of a larger Nᵣ×Nₜ channel matrix \tilde{H}, with columns of the matrix corresponding to the selected antennas. A signal to noise ratio (SNR) is denoted by γ, where

$$γ \underline{\underline{Δ}} {E}_{x} [ {\sum }_{i = 1}^{{L}_{t}} {\vert {x}_{i} \vert}^{2} ] .$$

### MIMO Channel Model:

A Kronecker model can model several typically encountered channels. See, e.g., J. P. Kermoal et al., A Stochastic MIMO Radio Channel Model with Experimental Validation, IEEE J. Select. Areas Commun., vol. 20, pp. 1211-1226, August 2002; and D. Asztely, On Antenna Arrays in Mobile Communication Systems: Fast Fading and GSM Base Station Receiver Algorithms, Tech. Rep. IR-S3-SB-9611, Royal Institute of Technology, March 1996, the contents of each of which are incorporated herein by reference. The forward channel matrix \tilde{H} can be written as

\tilde{H}=Rᵣ^{1/2}\tilde{H}_{w}\tilde{R}ₜ^{1/2}, (2)

where \tilde{R}ₜ is a Nₜ×Nₜ transmit-side correlation matrix, Rᵣ is a Nᵣ×Nᵣ receive-side correlation matrix, and \tilde{H}_{w} is an Nᵣ×Nₜ spatially white zero-mean unit variance complex i.i.d. Gaussian noise matrix. Therefore, the channel state information (H) between the selected transmit antennas and the receive antennas is given by H=Rᵣ^{1/2}H_{w}Rₜ^{1/2}, where Rₜ is an Lₜ×Lₜ principal submatrix of the matrix \tilde{R}ₜ with the rows and columns of the matrix H corresponding to the selected transmit antennas, and H_{w} is the corresponding Nᵣ×Lₜ sub-matrix of \tilde{H}_{w}.

For a uniform linear array (ULA) with a Gaussian angular distribution, the (i,j)^{th} element, rᵢⱼ, of the correlation matrix, \tilde{R}ₜ (or Rᵣ), can be calculated according to D. Asztely, On Antenna Arrays in Mobile Communication Systems: Fast Fading and GSM Base Station Receiver Algorithms, Tech. Rep. IR-S3-Sb-9611, Royal Institute of Technology, March 1996, using the following equation:

$${r}_{ij} = {\int }_{- ∞}^{+ ∞} {e}^{- j2 π ( i - j ) Δcos ( {θ}_{0} + θ )} \frac{1}{\sqrt{2 π} {σ}_{θ}} {e}^{- \frac{{θ}^{2}}{2 {σ}_{θ}^{2}}} d θ \approx {e}^{- j2 π ( i - j ) Δcos ( {θ}_{0} )} {e}^{- \frac{1}{2} {( 2 π ( i - j ) Δsin ( {θ}_{0} ) {σ}_{θ} )}^{2}} , \qquad ( 3 )$$

where j=\sqrt{−1}, θ₀ is the angle of departure (AoD) or AoA), σ_{θ} is the angular spread, and Δ is the wavelength-normalized antenna spacing. The approximation above holds for small σ_{θ} and predicts the correct trends for large σ₇₄. The correlation matrix for a uniform circular array (UCA) with a Laplacian distributed AoD (or AoA) is derived in J. -A. Tsai, R. M. Buehrer, and B. D. Woerner, Spatial Fading Correlation Function of Circular Antenna Arrays with Laplacian Energy Distribution, IEEE Commun. Lett., vol. 6, pp. 178-180, May 2002, the contents of which are herein incorporated by reference.

For transmit antenna selection, when Lₜ out of Nₜ antennas are to be selected, the total number of selections is

$$L = ( \begin{matrix}{N}_{t} \\ {L}_{t}\end{matrix} ) .$$

. Let each selection be denoted by the vector, sᵢ, which lists the indexes of the Lₜ transmit antennas selected. Therefore, sₗ=└sₗ₁,sₗ₂, . . . ,s_{lL}_{_{γ}}┘εI^{L}^{_{γ}}, for l=1, 2, . . . , L, where I Δ {1, 2, . . . ,Nₜ} and sₗᵢ≠sₗⱼ for i≠j. The symbol S denotes the set of all possible selections: S Δ {s₁,s₂, . . . ,s_{L}}. So that the transmitter will use the antenna subset sᵢ, the receiver sends the feedback codeword (bit sequence) cₗ Δ[cₗ₁,cₗ₂, . . . ,cₗₙ]εF^{N}, where F={0, 1}. C denotes the set of all feedback codewords (used bit sequences) C Δ{c₁,c₂, . . . ,c_{L}}. All the codewords include n bits. To ensure meaningful feedback, each selection is preferably represented by a unique bit sequence. Therefore, the length of the bit sequences, n, satisfies the constraint

$$n \geq ⌈ {log}_{2} ( \begin{matrix}{N}_{t} \\ {L}_{t}\end{matrix} ) ⌉ ,$$

where ┌.┐ is the ceiling function. For the purposes of the following non-limiting explanation, one antenna is assumed to be selected for transmission (e.g., Lₜ=1). For simplicity, Nₜ is taken to be a power of two, so that the total number of possible bit sequences and the number of antennas is the same, (i.e., n=log₂ Nₜ is an integer). Therefore, there exists a bijective mapping μ:S→C, called the signaling assignment, such that for all c ε C, there exists an s ε S such that c=μ(s), and μ(s₁)≠μ(s₂) if (s₁)≠(s₂).

While it is possible that 2ⁿ-Nₜ bit sequences may exist that are not codewords if Nₜ is not a power of two, the present invention assumes (as a non-limiting example) that these sequences are mapped based on a pre-specified rule. Of course, other solutions to feedback error resulting in a codeword being received at the transmitter that is not in the codebook are within the scope of the present invention.

In this non-limiting example, it is assumed that the feedback channel is a binary symmetric channel (BSC) with a crossover probability of ε, where 0<ε<1. Errors in the feedback channel result in the transmitter receiving a bit sequence, c′, that is different from the one sent by the receiver, c. Therefore, c′ is another (different) element of C. Using this notation, transmit antenna selection with erroneous feedback can be described as follows: Let s denote the optimum choice made by the receiver. The receiver signals the codeword c=μ(s), which is received by the transmitter as c′. The transmitter then uses the antenna set s′=μ⁻¹(c′). Given that μ(.) is bijective, it follows that μ⁻¹(c′)≠μ⁻¹(c).

However, all the errors are not equally likely. If the Hamming distance between two bit sequences is d, then the probability of erroneously interpreting these two bit sequences is given by the function

Φ(d)=ε^{d}(1−ε)^{n-d} (4)

Thus, different Hamming distances lead to different error probabilities. In the absence of spatial correlation, the average standard error of prediction (SEP) of the data can be independent of the signaling assignment. However, in the presence of correlation, the performance degradation can be reduced if the most probable feedback error patterns cause the transmitter to select antenna(s) that are highly correlated with the transmit antennas selected by the receiver. To verify this intuition, a non-limiting example consisting of Nₜ=4 and Nᵣ=1 antennas, out of which Lₜ=1 antenna is used for transmission is illustrated in FIG. 2. Two feedback bits are used to uniquely identify the selected antenna. The performance for two feedback bit error rates, ε=0.1% and ε=4%, is shown. The transmit correlation matrix used in this example corresponds to an angle spread of σ_{θ}=30° and a mean AoD of 30°.

In a non-limiting example of the present invention, Monte Carlo simulations were used to obtain the average SEPs of the 24 total possible signaling assignments at different SNRs. FIG. 2 illustrates two non-limiting examples of SEP with respect to SNR. As is illustrated in FIG. 2, a receiver that has ideal selection verification performs better than a receiver that has no selection verification.

While the ideal selection receiver is difficult to achieve, the methods set forth in step S212 of FIG. 11 approach this ideal. It can be seen that the performance gap between the best and the worst signaling assignments is about 1.5 dB for ideal selection verification. And for no-selection verification, the best and the worst signaling assignments lead to an error floor which is of the order of nε. While the performance loss is negligible for ε=0.1%, except at high SNR, the performance loss is significant for ε=4%.

### Antenna Selection Verification:

According to this non-limiting example, the receiver is assumed to know the complex channel matrix \tilde{H}. However, due to the presence of feedback errors, the receiver might not know a priori the actual antennas selected for transmission. One goal of the receiver is to detect the transmission data correctly. For this, the receiver often needs to estimate, as an intermediate step, which antenna was selected by the transmitter. Hereafter, s, s′, and ŝ denote the antennas selected and fed back by the receiver, the antennas actually used by the transmitter, and the antennas assumed by the receiver during data detection, respectively. Their corresponding channel coefficients are denoted by hₛ, h_{s′}, and h_{ŝ}. These correspond to appropriate columns of the complete channel matrix \tilde{H}.

A receiver that ignores the possibility of feedback error and assumes that the transmitter used the antennas of s, (e.g., the antennas recommended by the receiver) is called the no-selection verification receiver. This receiver assumes that ŝ=s and uses the channel hₛ to do detection. On the other hand, if the receiver always knows that the antennas s′ was used by the transmitter, the receiver shall be called the ideal selection verification receiver. Therefore, the receiver assumes ŝ=s′ and correctly uses h_{s′} to do detection. A receiver that determines ŝ using only the received signal, y, given a priori knowledge of the feedback error rate ε is called a blind optimal selection verification receiver. If additional side information is also available to determine ŝ as described below, then the non-blind selection verification receiver applies. To quantify the efficacy of the selection verification process, two verification-related probabilities are defined as follows:

Antenna selection verification error at transmitter:

$${P}_{ver}^{( T )} \underline{\underline{Δ}} Pr ( \hat{s} \neq {s}^{′} ) , and \qquad ( 5 )$$

Antenna selection verification mismatch probability:

$${P}_{ver}^{( R )} \underline{\underline{Δ}} Pr ( \hat{s} \neq {s}^{′} ) . \qquad ( 6 )$$

Pᵥₑᵣ^{(T)} is the probability that the receiver cannot determine which transmit antenna was actually used. Pᵥₑᵣ^{(R)} is the probability that the transmit antenna estimate of the receiver does not match its initial (optimum) choice. Obviously, Pᵥₑᵣ^{(T)}=0 for ideal selection verification, and Pᵥₑᵣ^{(R)}=0 for no-selection verification.

Let M_{L} denote the set of all the bijective mappings between two sets of cardinality L. Then, the optimal signaling assignment, μ*, for a given SNR, γ, is given as:

$${μ}^{*} ( γ ) = arg \begin{matrix}min \\ μ ∈ {M}_{L}\end{matrix} {P}_{e} ( μ ; γ ) . \qquad ( 7 )$$

where Pₑ(μ; γ) denotes the average symbol error probability (SEP) for the signaling assignment μ at SNR γ. Arguably, while the optimal assignment μ* can depend on the operating γ, the results in FIG. 2 (and others described below) show that for ideal selection verification and no-selection verification, the same signaling assignment is optimal for all SNR. For other receivers, this might not be true, as is described in later sections.

In the following non-limiting example, only Lₜ=1 transmit antenna is selected from the Nₜ antennas. In this case, the optimal choice of transmit antenna is

$$s = arg {max}_{j} {‖ {h}_{j} ‖}^{2} , \qquad ( 8 )$$

where hⱼ denotes the j^{th} column of the matrix \tilde{H}. The decision statistic used by the receiver, given that it uses Ŝ as its estimate of the antenna used for transmission and knows \tilde{H}, is

ŷ=h_{ŝ}^{†}h_{s′}x+h_{ŝ}^{†}w. (9)

The output of the detector is denoted by \hat{x}.

The average symbol error probability for a given signaling assignment, μ, is given by

$${P}_{e} ( μ ; γ ) = {\sum }_{s , {s}^{′} , \hat{s} ∈ S} {E}_{x \vert s , {s}^{′} , \hat{s}} [ Pr ( \begin{matrix} \hat{x} \neq \\ x \vert s , \\ {s}^{′} , \hat{s}\end{matrix} ) ] Pr ( \hat{s} \vert s , {s}^{′} ) Pr ( {s}^{′} \vert s ) Pr ( s ) . \qquad ( 10 )$$

The probability Pr(ŝ|s′, s) depends on the selection verification algorithm used at the receiver. For ideal selection verification, we have Pr(ŝ=s′|s′,s)=1; while for no-selection verification, only Pr(s|s′, s)=1. Therefore, in these two cases, in which ŝ is a deterministic function of s and s′, (10) can be simplified to:

$${P}_{e} ( μ ; γ ) = {\sum }_{s , {s}^{′} ∈ S} {E}_{x \vert s , {s}^{′}} [ Pr ( \hat{x} \neq x \vert s , {s}^{′} ) ] Pr ( {s}^{′} \vert s ) Pr ( s ) . \qquad ( 11 )$$

The term Pr(s′|s) depends on the feedback error rate E and the signaling assignment μ because

Pr(s′|s)=Φ(d(c′, c))=ε^{d(c′)}(1−ε)^{(n-d(c′,c))}, (12)

where c′=μ(s′), c=μ(s), and d(c, c′) denotes the Hamming distance between the two codewords c and c′. Pr(s) is the probability that s is the optimal transmit antenna. In the presence of spatial correlation, it is not the same for all s. However, for moderate spatial correlations, the difference between these probabilities is minor enough to justify the approximation Pr(s)≈1/L. Substituting this approximation into (11) and given that only one antenna is used for transmission yields the following expression for Pₑ(μ;γ):

$${P}_{e} ( μ ; γ ) \approx \frac{1}{{N}_{t}} {\sum }_{s , {s}^{′}} {E}_{x \vert s , {s}^{′}} [ Pr ( \hat{x} \neq x \vert s , {s}^{′} ) ] Φ ( d ( μ μ ( c ) , μ ( c ) ) ) . \qquad ( 13 )$$

The average SEP given s and s′, E_{x|s,s′}[Pr(\hat{x}≠x| s,s′)], depends on the modulation constellation, the receiver, and the channel statistics. In the presence of spatial correlation and antenna selection, the combination of spatial correlation and order statistics makes it difficult to derive general closed-form expressions for the above expectation. Evaluating it equation 13 numerically or using Monte Carlo simulations makes it infeasible for optimization purposes. We therefore develop very simple approximations that are based only on the second-order statistics of the channel. These are sufficiently accurate for the purposes of optimization. In the following, we develop suitable approximations for E_{x|s,s′}[Pr(\hat{x}≠x|s,s′)] for ideal selection verification and no-selection verification.

With ideal antenna selection verification, we have ŝ=s′. Therefore, the decision statistic becomes

ŷ=∥h_{s′}∥²x+h_{s′}^{†}w, (14)

When QPSK modulation is used, the SEP, given h_{s′}, approximately equals 2Q(\sqrt{γ∥h_{s′}∥^{s}/2}). Therefore,

$$\begin{matrix}Pr ( \hat{x} \neq x \vert s , {s}^{′} ) = {E}_{{h}_{s} \vert s , {s}^{′}} [ Pr ( \hat{x} \neq x \vert {h}_{{s}^{′}} , s , {s}^{′} ) ] , & ( 15 ) \\ = {E}_{{h}_{{s}^{′}} \vert s , {s}^{′}} [ 2 Q ( \sqrt{\frac{γ}{2} {‖ {h}_{{s}^{′}} ‖}^{2}} ) ] , & \\ \approx 2 Q ( \sqrt{\frac{γ}{2} {E}_{{h}_{{s}^{′}} \vert s , {s}^{′}} [ {‖ {h}_{{s}^{′}} ‖}^{2} ]} ) & ( 16 ) \end{matrix}$$

In (16), the expectation operator is interchanged with the Q function. From Jensen's inequality, the resulting expression is a lower bound on the average SEP.

From the spatial correlation model defined in (2), the correlation between h_{s′} and hₛ is r_{ss′}. Then, h_{s′} can be written in terms of hₛ as h_{ŝ}=r_{ss′}hₛ+\sqrt{1−|r_{ss′}|²}n. The vector n is independent of h_{ŝ} and hₛ, and each of its elements is a zero-mean unit-variance complex Gaussian RV. Therefore, Eₕ_{_{s′}}_{|s,s′}└∥h_{s′}∥²┘=|r_{ss′}|²Eₕ_{ₛ}_{|s}└∥hₛ∥²┘+(1−|r_{ss′}|²)Nᵣ. As a result,

$$\begin{matrix}Pr ( \hat{x} \neq x \vert s , {s}^{′} ) \approx 2 Q ( \sqrt{\frac{γ}{2} {\vert {r}_{{ss}^{′}} \vert}^{2} ( {E}_{{h}_{s} \vert s} [ {‖ {h}_{s} ‖}^{2} ] - {N}_{r} ) + \frac{{N}_{r} γ}{2}} ) , & ( 17 ) \\ \approx 2 exp ( - \frac{γ}{4} {\vert {r}_{{ss}^{′}} \vert}^{2} ( {E}_{{h}_{s} \vert s} [ {‖ {h}_{s} ‖}^{2} ] - {N}_{r} ) - \frac{{N}_{r} γ}{4} ) , & \\ = 2 exp ( - {β}_{ver} ( γ ) {\vert {r}_{{ss}^{′}} \vert}^{2} ) exp ( - \frac{{N}_{r} γ}{4} ) . & ( 18 )\end{matrix}$$

In (17), Q(a)≈exp(−a²/2) for a>0. The term βᵥₑᵣ(γ) in (18) denotes

$$- \frac{γ}{4} ( {E}_{{h}_{s} \vert s} [ {‖ {h}_{s} ‖}^{2} ] - {N}_{r} )$$

as Eₕ_{ₛ}_{|s}└∥hₛ∥^{s}┘ is independent of μ. It must be noted that βᵥₑᵣ(γ)>0, because ∥hₛ∥^{s} is the maximum of the column norms of \tilde{H}.

Because the signal x is QPSK modulated and the constellation symbols are equi-probable, we have E_{x|s.s′}[Pr(\hat{x}≠x|s,s′]=Pr(\hat{x}≠xs, s′). Substituting the expressions for Pr(\hat{x}≠x|s,s′) in (18) and for Φ( ) in (4) in (11), we get:

$${P}_{e} ( μ ; γ ) \approx \frac{2}{{N}_{t}} exp ( - \frac{γ}{4} ) {( 1 - ∈ )}^{n} {\sum }_{s ∈ S}^{ } {\sum }_{{s}^{′} ∈ S}^{ } 2 exp ( - {β}_{ver} ( γ ) {\vert {r}_{{ss}^{′}} \vert}^{2} ) {( \frac{∈}{1 - ∈} )}^{d ( μ ( s ) , μ ( {s}^{′} ) )} . \qquad ( 19 )$$

Therefore, we can define the metric, Mᵥₑᵣ(μ; γ), for ideal selection verification as

$${M}_{ver} ( μ ; γ ) {=}^{Δ} {\sum }_{s ∈ S}^{ } {\sum }_{{s}^{′} ∈ S}^{ } exp ( - {β}_{ver} ( γ ) {\vert {r}_{{ss}^{′}} \vert}^{2} ) {( \frac{∈}{1 - ∈} )}^{d ( μ ( s ) , μ ( {s}^{′} ) )} \qquad ( 20 )$$

The common term

$$\frac{2}{{N}_{t}} exp ( - \frac{{N}_{r} γ}{4} ) {( 1 - ∈ )}^{n} ,$$

which does not depend on μ, is dropped in (20).

### No Antenna Selection Verification:

A receiver without antenna selection verification uses ŝ=s. Therefore, the decision statistic in this receiver is

ŷ=hₛ^{†}h_{s′}x+hₛ^{†}w. (21)

As a result, when the signal x is QPSK modulated, we have

$$\begin{matrix}Pr ( \hat{x} \neq x \vert s , {s}^{′} ) = {E}_{{h}_{{s}^{′}} , {h}_{s} \vert s , {s}^{′}} [ Pr ( \hat{x} \neq x \vert {h}_{{s}^{′}} , {h}_{s} , s , {s}^{′} ) ] \\ = {E}_{{h}_{{s}^{′}} , {h}_{s} \vert s , {s}^{′}} [ Q ( \sqrt{\frac{γ}{2}} \frac{\vert {h}_{s}^{†} {h}_{{s}^{′}} \vert}{‖ {h}_{s} ‖} cos ( \frac{π}{4} + φ ) ) + \\ Q ( \sqrt{\frac{γ}{2}} \frac{\vert {h}_{s}^{†} {h}_{{s}^{′}} \vert}{‖ {h}_{s} ‖} sin ( \frac{π}{4} + φ ) ) ] ,\end{matrix}$$

where φ is the phase of the complex number hₛ^{†}h_{s′}. It is a zero-mean RV, and its variance decreases as the spatial correlation increases. For small φ, we have |sin(φ)|<<|cos(φ)|. This justifies the following approximation:

$$cos ( \frac{π}{4} + φ ) + \frac{1}{\sqrt{2}} cos ( φ ) - \frac{1}{\sqrt{2}} sin ( φ ) \approx \frac{1}{\sqrt{2}} cos ( φ ) .$$

Similarly, sin

$$( \frac{π}{4} + φ ) \approx \frac{1}{\sqrt{2}} cos ( φ ) .$$

### Therefore,

$$Pr ( \hat{x} \neq x \vert {h}_{{s}^{′}} , {h}_{s} , s , {s}^{′} ) \approx 2 Q ( \sqrt{\frac{γ}{4}} \frac{\vert {h}_{s}^{†} {h}_{{s}^{′}} \vert}{‖ {h}_{s} ‖} cos ( φ ) ) . \qquad ( 22 )$$

As before, the spatial correlation between hₛ and h_{s′}implies that

h_{s′}=r_{ss′}hₛ+\sqrt{1−|r_{ss′}|²}n,

[symbol]

|hₛ^{†}h_{s′}|cos(φ)=∥hₛ∥^{s}Re{\sqrt{1−|r_{ss′}|²}hₛ^{†}n}, (23)

where n is a zero-mean AWCGN and is independent of hₛ and h_{s′}. Therefore,

$$Pr ( \hat{x} \neq x \vert {h}_{{s}^{′}} , {h}_{s} , s , {s}^{′} ) \approx 2 Q ( \begin{matrix}\sqrt{\frac{γ}{4}} ‖ {h}_{s} ‖ Re \{ {r}_{{ss}^{′}} \} + \\ Re \{ \sqrt{1 - {\vert {r}_{{ss}^{′}} \vert}^{2}} \frac{{h}_{s}^{†} n}{‖ {h}_{s} ‖} \}\end{matrix} ) . \qquad ( 24 )$$

Then Pr(\hat{x}≠x|s,s′) can be approximated by

$$\begin{matrix}Pr ( \hat{x} \neq x \vert s , {s}^{′} ) \approx Q ( \sqrt{\frac{γ}{4}} {E}_{{h}_{{s}^{′}} \vert s , {s}^{′}} [ ‖ {h}_{s} ‖ ] Re \{ {r}_{{ss}^{′}} \} ) , \\ = 2 Q ( {β}_{no - ver} ( γ ) Re \{ {r}_{{ss}^{′}} \} ) .\end{matrix} \qquad ( 25 )$$

The first step of the approximation swaps the expectation operator and the Q function. From Jensen's inequality, the resulting expression is a lower bound on the average SEP. This step also uses the fact that

$${E}_{{h}_{s} , n \vert s , {s}^{′}} [ Re \{ \sqrt{1 - {\vert {r}_{{ss}^{′}} \vert}^{2}} \frac{{h}_{s}^{†} n}{‖ {h}_{s} ‖} \} ] = 0$$

because n is a zero-mean RV that is independent of hₛ. In (25), βₙₒ₋ᵥₑᵣ(γ) denotes

$$\sqrt{\frac{γ}{4}} {E}_{{h}_{{s}^{′}} \vert s , {s}^{′}} [ ‖ {h}_{s} ‖ ] ,$$

which is independent of μ. Note that it is preferred not to use the approximation, Q(a)≈exp(−a²/2), because Re {r_{ss′}} can be negative.

Upon substituting (25) and (4) in (13), we get the following approximation for Pₑ(μ; γ):

$${P}_{e} ( μ ; γ ) \approx \frac{2}{{N}_{t}} {( 1 - ∈ )}^{n} {\sum }_{s ∈ S} {\sum }_{{s}^{′} ∈ S} Q ( \begin{matrix}{β}_{no - ver} ( γ ) \\ Re \{ {r}_{{ss}^{′}} \}\end{matrix} ) {( \frac{∈}{1 - ∈} )}^{d ( \begin{matrix}μ ( {s}^{′} ) , \\ μ ( s )\end{matrix} )} \qquad ( 26 )$$

Therefore, we can define the metric Mₙₒ₋ᵥₑᵣ(μ; γ) for no-selection verification as:

$${M}_{no - ver} ( μ ; γ ) {=}^{△} {\sum }_{s ∈ S} {\sum }_{{s}^{′} ∈ S} Q ( \begin{matrix}{β}_{no - ver} ( γ ) \\ Re \{ {r}_{{ss}^{′}} \}\end{matrix} ) {( \frac{∈}{1 - ∈} )}^{d ( \begin{matrix}μ ( {s}^{′} ) , \\ μ ( s )\end{matrix} )} \qquad ( 27 )$$

The common term,

$$\frac{2}{{N}_{t}} {( 1 - ∈ )}^{n} ,$$

which is independent of μ, is dropped in the above definition.

### Verification of Approximate Metrics:

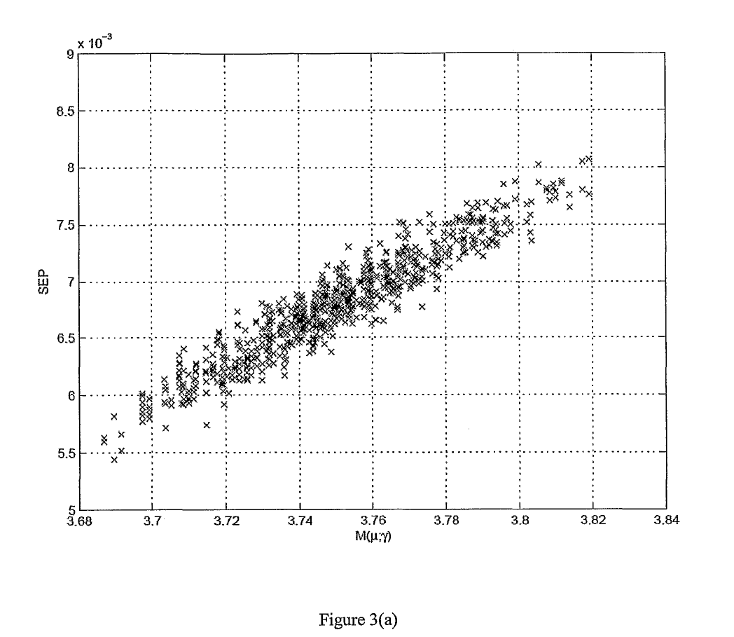

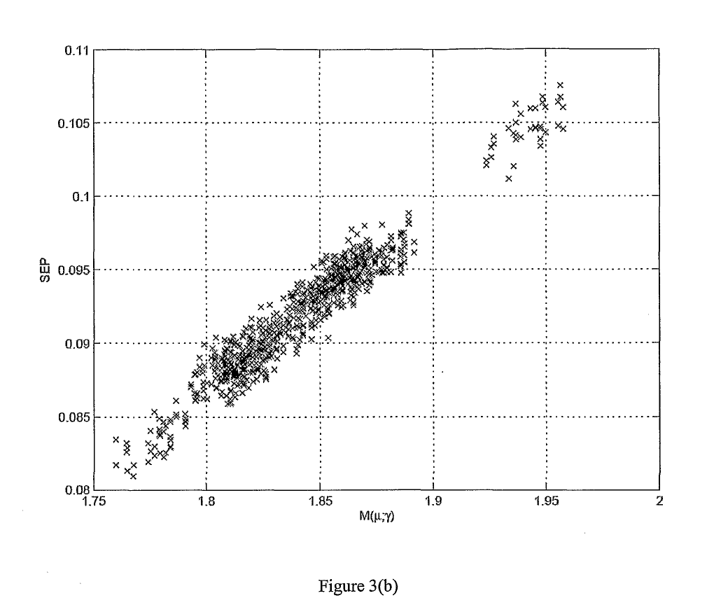

FIG. 3(a) is a scatter plot of the simulated Pₑ(γ, μ) and the metric Mᵥₑᵣ(μ; γ), defined in (20), for ideal selection verification and y=6 dB. A total of 800 different assignments for Nₜ=8 and Nᵣ=1 with Lₜ=1 are plotted. A total of 40320 assignments are possible. The SNR dependent term, βᵥₑᵣ(γ), is set to unity.

The strong monotonic relationship between the metric and the average SEP is evident from the plot. So long as this monotonic relationship holds, the metric can be used to compare the various signaling assignments and find the optimal one. On account of the approximations made in the derivation of the metric Mᵥₑᵣ(μ; γ), the plot displays some scatter. This scatter implies that for a given value of the metric, some uncertainty exists about the exact SEP value. However, it should be noted that the primary region of interest for optimization purposes is the one with lower values of both Pₑ(μ; γ) and Mᵥₑᵣ(μ; γ).

FIG. 3(b) is a scatter plot of the average SEP from simulations and the metric Mₙₒ₋ᵥₑᵣ(μ; γ), defined in (27), for no-selection verification. As before, Mₙₒ₋ᵥₑᵣ(γ) is set to unity. The monotonic relationship again holds.

To verify the validity of these approximations, brute force simulations were done for several systems with different number of antennas and spatial correlations. In each case, the plot of the average SEP displayed the desired monotonic relationship with the metrics for both ideal selection verification and no-selection verification. The monotonic relationship holds regardless of the value of βᵥₑᵣ(γ) and βₙₒ₋ᵥₑᵣ(γ). Therefore, these approximations were set to 1 for the following non-limiting explanation of the present invention.

The metrics defined in (20) and (27) depend on system parameters such as the feedback bit error rate, E and the transmit correlation \tilde{R}ₜ. The following non-limiting embodiment and description of the present invention relates to the robustness of the optimal signaling assignment to changes in these system parameters.

Lemma 1: For small feedback bit error probabilities, ε<<1, the optimal signaling assignments, μᵥₑᵣ* and μₙₒ₋ᵥₑᵣ*, are independent of ε.

Proof: Let Ŝₛ(μ) denote the set of all transmit antenna indices whose codewords are 1 bit apart from the codeword μ(s). Hence, Ŝₛ(μ)Δ{s′|s′εS and d(μ(s′),μ(s))=1}. When ε<<1, single bit errors are most likely. Therefore, the metrics simplify to:

$$\begin{matrix}{M}_{ver} ( μ ; γ ) = \frac{∈}{1 - ∈} {\sum }_{s ∈ S} {\sum }_{{s}^{′} ∈ {\hat{S}}_{s} ( μ )} exp ( - β ( γ ) {\vert {r}_{{ss}^{′}} \vert}^{2} ) + o ( ∈ ) , \\ and & ( 28 ) \\ {M}_{no - ver} ( μ ; γ ) = \frac{∈}{1 - ∈} {\sum }_{s ∈ S} {\sum }_{{s}^{′} ∈ {\hat{S}}_{s} ( μ )} Q ( β ( γ ) Re \{ {r}_{{ss}^{′}} \} ) + o ( ∈ ) , & ( 29 )\end{matrix}$$

where lim_{ε→0} o(ε)/ε=0. Therefore, for ε<<1, the metrics depend on E only through the common term ε/(1−ε), which implies that the optimal signaling assignments are independent of ε, as described in K. Zeger and A. Gersho, Pseudo-Gray Coding, IEEE Trans. Commun., vol. 38, pp. 2147-2158, November 1990, the contents of which are herein incorporated by reference.

For ideal selection verification, the absolute value of the complex spatial correlation coefficient matters, and not its phase. While a different angle spread and a different mean AoD changes the value of the correlation, it follows from (3) that antenna spatially farther apart have a smaller absolute value of correlation than antennas that are closer. Therefore, the optimal signaling assignment derived for one set of parameters will perform well even under a different set of parameters.

The analysis of the previous non-limiting example results in metrics that depend only on the second-order statistics of the channel. The problem at hand is to find the signaling assignment that minimizes the metrics defined in (20) and (27) for ideal selection verification and no-selection verification, respectively.

If there are L codewords, then the total number of signaling assignments is L!. Given a signaling assignment, swapping the Os and is in its codewords leads to another signaling assignment with exactly the same performance, because the feedback channel is a BSC. Therefore, the search space can be reduced to L!/2. Therefore, the complexity of the search for the optimal signaling assignment μ* is very high even for moderate values of Nₜ and Lₜ.

The Binary Switching Algorithm (BSA) searches to find a locally optimal signaling assignment in the set of all assignments M_{L}. If only one transmit antenna is chosen from Nₜ antennas, then the number of possible selections of transmit antennas is L=Nₜ. To run BSA, it is useful to define the cost function for each choice; the total cost is the sum of the costs of all choices. In the present non-limiting example, the total cost is defined as M(μ; γ), where M(μ;γ)ΔMₙₒ₋ᵥₑᵣ(μ;γ) for no-selection verification and M(μ;γ)ΔMᵥₑᵣ(μ;γ) for ideal selection verification. Correspondingly, the cost for each selection, s ε S is defined as:

$${\hat{M}}_{s} ( μ ; γ ) = {\sum }_{{s}^{′} ∈ S} exp ( - β ( γ ) {\vert {r}_{{ss}^{′}} \vert}^{2} ) {( \frac{∈}{1 - ∈} )}^{d ( μ ( s ) , μ ( {s}^{′} ) )} , \qquad ( 30 )$$

for ideal selection verification, and

$${\hat{M}}_{s} ( μ ; γ ) = {\sum }_{{s}^{′} ∈ S} Q ( β ( γ ) Re \{ {r}_{{ss}^{′}} \} ) {( \frac{∈}{1 - ∈} )}^{d ( μ ( s ) , μ ( {s}^{′} ) )} , \qquad ( 31 )$$

for no-selection verification. Clearly,

$$M ( μ ; γ ) = {\sum }_{s ∈ S} {\hat{M}}_{s} ( μ ; γ ) .$$

Generally, the steps of BSA are as follows: 1) Randomly select the initial signaling assignment, μ. 2) Calculate the cost function, \hat{M}ₛ(μ;γ), for each selection s ε S, and the total cost M(μ; γ). 3) Sort the elements in the set {\hat{M}ₛ(μ;γ)|s ε S} in increasing order. 4) Switch the selection with the highest cost with every other selection. Each switch changes μ to a different signaling assignment, say, μ′. For each switch, calculate the new total cost M(μ′;γ). 5) Pick the switch with the lowest total cost. If it is lower than the initial total cost, save the corresponding signaling assignment, and return to step 2. If it is higher than the initial total cost, then proceed to 6. 6) Switch the selection with the second highest cost with every other choice, and calculate the total cost for each switch. 7) Pick the switch with lowest total cost. If this total cost is lower than the initial cost, save the corresponding signaling assignment, and return to 2. Else, if the total cost is higher than the initial total cost, stop.

The metrics described herein enable a general formulation based on a combinatorial optimization problem known as the quadratic assignment problem. See, P. M. Pardalos, F. Rendl, and H. Wolkowicz, The Quadratic Assignment Problem: A Survey of Recent Developments in Quadratic Assignment and Related Problems, P. Pardalos and H. Wolkowicz, eds., vol. 16, pp 1-42, DIMACS Series in Discrete Mathematics and Theoretical Computer Science (1994), the entire contents of which are herein incorporated by reference. The QAP attempts to find the permutation which minimizes a cost function of the form

$${min}_{μ ∈ {M}_{L}} {\sum }_{i ∈ Z} {\sum }_{j ∈ Z} {f}_{ij} {g}_{μ ( i ) μ ( j )} ,$$

where M_{L} is the set of all possible permutations of the set Z={1,2, . . . , L}. As we saw, different permutations correspond to different signaling assignments. In one non fᵢⱼ=exp(−β(γ)|rᵢⱼ|²)-limiting example of the present invention, L=Nₜ, and the function fᵢⱼ is given by for perfect selection verification and by fᵢⱼ=Q(β(γ) Re(rᵢⱼ)) for no-selection verification. The function g_{μ(i)μ(j)} is given by

$${g}_{μ ( i ) μ ( j )} = {( \frac{∈}{1 - ∈} )}^{d ( μ ( i ) , μ ( j ) )} ,$$

and μ(i) and μ(j) are the codewords assigned to transmit antenna indices i and j, respectively. Therefore, efficient algorithms, such as Tebu search, developed for QAP can now be applied to the present invention.

The BSA is guaranteed to stop, and it converges to a locally optimum signaling assignment in many cases. To find the global optimum, the process is started with several different initial signaling assignments, and the assignment with the lowest total cost is selected. The complexity of BSA is of the order of Nₜ³. The complexity can be reduced to Nₜ² log₂ (Nₜ) for ε<<1, when only single feedback bit errors are very likely.

The results of FIG. 2 illustrate the possible benefits of using antenna selection verification at the receiver. Not doing so may lead to an error floor that is of the order of the feedback codeword error rate. In systems in which the feedback error rate is higher than the transmit data error rates, as is typically the case, this may be an unacceptable degradation in performance.

It is also possible to develop processes that are tailored to the knowledge available at the receiver. These fall into two categories: blind antenna selection verification, in which there is no additional side information available at the receiver, and non-blind antenna selection verification, in which additional side information is available.

### Blind Antenna Selection Verification:

A blind antenna selection verification receiver detects the transmitted symbol as well as the antenna used to transmit it from the received data only. In addition, the receiver also has access to the a priori information of which antenna it asked the transmitter to use. Therefore, the following detection rule minimizes the SEP:

$$\hat{x} = {arg max}_{x} \{ Pr ( x \vert y , s , \tilde{H} ) \} = {arg max}_{x} \{ p ( y \vert x , s , \tilde{H} \} \qquad ( 32 )$$

where the last step follows because all candidates of x are equi-probable and are independent of s and \tilde{H}. The previous equation can be simplified as:

$$\begin{matrix}\hat{x} = {arg max}_{x} \{ {\sum }_{{s}^{′}} p ( y \vert x , {s}^{′} , s , \tilde{H} ) Pr ( {s}^{′} \vert s ) \} , & ( 33 ) \\ = arg {m a x}_{x} \{ {\sum }_{{s}^{′}} p ( y \vert x , {h}_{{s}^{′}} ) Φ ( d ( μ ( s ) , μ ( {s}^{′} ) ) ) \} . & ( 34 )\end{matrix}$$

Equation (33) follows from (32) because the feedback errors are independent of the forward link channel state. In (34), it is notable that given h_{s′}, y is independent of s and \tilde{H}. The receiver based on (34) is referred to as the blind optimal symbol-level selection verification receiver. Note that it considers all the possible choices of transmit antennas, and does not determine s′ as an intermediate step. Therefore, the verification-related probabilities Pᵥₑᵣ^{(T)} and Pᵥₑᵣ^{(R)}, defined in (5) and (6), respectively, are not applicable here.

The term p(y|x, h_{s′}) in (34) is an exponential term as it is a Gaussian pdf. By using the approximation log

$$( {\sum }_{i} {e}^{{χ}_{i}} ) \approx {max}_{i} \{ {χ}_{i} \} ,$$

(34) can be further simplified to:

$$\{ \hat{x} ; \hat{s} \} = \begin{matrix}arg max \\ x ; {s}^{′}\end{matrix} \{ - {‖ y - {h}_{{s}^{′}} x ‖}^{2} + log Φ ( d ( μ ( s ) , μ ( {s}^{′} ) ) ) \} , \qquad ( 35 )$$

where ŝ is transmit antenna assumed by the receiver for data estimation. Because the noise is assumed to have unit variance, the term μy−h_{s′}x∥² is not multiplied with any scaling factor. The receiver based on (35) shall be called the blind sub-optimal symbol-level selection verification receiver. While (35) is a sub-optimal approximation to (34), it will later be evident that the performance penalty is extremely negligible. Moreover, taking the logarithm avoids numerical overflow and underflow problems in evaluating equation 34. For the purposes of the discussion below, the two equations are not distinguished.

The number of possibilities to be considered by the antenna verification receiver in (34) and (35) is 4Nₜ because the QPSK constellation consists of 4 symbols and the number of possible choices of transmit antennas is Nₜ. For ε<<1 this complexity can be reduced by only searching over the most probable set of s′. This set corresponds to antennas with codewords that differ from the codeword(s) by only 1 bit. The number of possibilities then reduces to 4┌log₂Nₜ┐.

The selection verification algorithm above is optimal only if the channel changes from one symbol transmission to another. If the channel is block-fading and remains constant over at least K>1 transmissions, then the antenna selection verification performance can be improved by doing it on a block-by-block basis. The optimal receiver now detects the sequence {\hat{x}₁,\hat{x}₂, . . . ,\hat{x}_{K}} as follows:

$$\{ {\hat{x}}_{1} , {\hat{x}}_{2} , … , {\hat{x}}_{K} \} {arg max}_{{x}_{1} , … , {x}_{K}} \{ {\sum }_{{s}^{′}} [ {\prod }_{i = 1}^{K} p ( {y}_{i} \vert {x}_{i} , {h}_{{s}^{′}} ) ] Pr ( {s}^{′} \vert s ) \} . \qquad ( 36 )$$

As before, (36) can be approximated by:

$$\{ {\hat{x}}_{1} , {\hat{x}}_{2} , … , {\hat{x}}_{K} ; \hat{s} \} {arg max}_{{x}_{1} , … , {x}_{K} ; {s}^{′}} \{ \begin{matrix}- {{\sum }^{K}}_{i = 1} {‖ {y}_{i} - {h}_{{s}^{′}} {x}_{i} ‖}^{2} + \\ log Φ ( d ( μ ( {s}^{′} ) , μ ( s ) ) ) .\end{matrix} \} \qquad ( 37 )$$

The optimal and sub-optimal receivers based on (36)) and (37), are referred to respectively, as blind block-level selection verification receivers. While block-level selection verification outperforms symbol-level selection verification, the complexity of the verification increases exponentially with the block fading length as the number of possibilities is of the order of 4^{K}Nₜ. Therefore, block-level selection verification quickly become impractical even for moderate K.

While optimal blind selection verification overcomes the catastrophic error floor limitation of no-selection verification, it is evident that there is still a large performance gap compared to ideal selection verification. In fact, the SEP performance is now limited largely by Pᵥₑᵣ^{(T)}. Therefore, additional side information is desirable to further reduce the selection verification error. Additional side information can be incorporated into the system by making the transmitter transmit from the selected antenna a short pilot symbol sequence before the data.

Let the antenna be selected once every K symbols, where K is smaller than the block fading duration. Transmission using the selected antenna occurs in two phases: first Kₚ symbols are used for the pilot; then the remaining K_{d}=K−Kₚ symbols are used for data. We also assume that the transmit power can be varied during the two phases. A fraction a of the total energy is allocated to the pilot symbols and the remaining energy is allocated to data symbols.

In a training phase, the transmitter sends a 1 x Kₚ pilot symbol vector xₚ. The receiver receives:

Yₚ=h_{s′}xₚ+Wₚ, (38)

where Wₚ is the Nᵣ x Kₚ zero-mean unit-variance AWCGN. Since xₚ is known by the receiver, the optimal rule for ŝ is as follows:

$$\begin{matrix}\hat{s} = {arg max}_{{s}^{′}} \{ Pr ( {s}^{′} \vert {Y}_{p} , {x}_{p} , s , \tilde{H} ) \} & ( 39 ) \\ = {arg max}_{{s}^{′}} \{ p ( {Y}_{p} \vert {x}_{p} , s , {s}^{′} , \tilde{H} ) Pr ( {s}^{′} \vert s ) \} , & ( 40 ) \\ = {arg max}_{{s}^{′}} \{ - {‖ {Y}_{p} = {h}_{{s}^{′}} {x}_{p} ‖}_{F}^{2} + log Φ ( d ( μ ( {s}^{′} ) , μ ( s ) ) ) \} . & ( 41 )\end{matrix}$$

Here, (40) follows from Baye's rule and Pr(s′|s,\tilde{H},xₚ)=Pr(s′|s) because the errors on the feedback channel are independent of the forward channel, \tilde{H}, and xₚ. Equation (41) follows because p(Yₚ|xₚ,s,s′,\tilde{H})=P(Yₚ|xₚ,h_{s′}).

After the receiver estimates ŝ, the receiver uses h_{ŝ} to detect the transmitted data. Keeping in mind the complexity of blind selection verification, it is assumed that the receiver does not use the data signals to refine its selection estimate, ŝ. The receiver based on (41) is referred to as the non-blind optimal selection verification receiver.

In the numerical results that follow, the error rate of the feedback channel is ε=0.04. A ULA is considered with a wavelength-normalized spacing of Δ=0.5. The angular spread is σ_{θ}=30° and the mean AoD is θ₀=30° in (3).

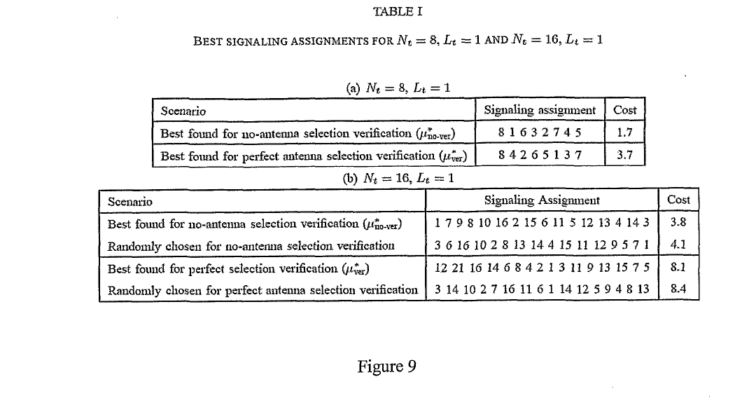

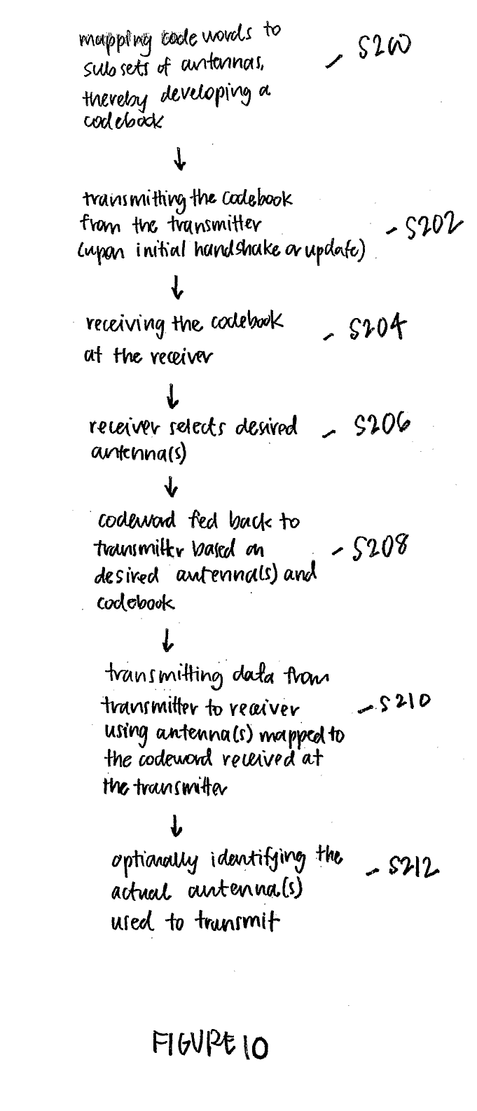

Table I(a) (illustrated in FIG. 9) lists the best signaling assignments that were found using BSA for ideal selection verification and no-selection verification for Nₜ=8. A brute force search over the possible 40320 assignments confirmed the results. The decimal notation is used to denote the binary codewords (i.e., 000 is denoted by 1, 001 by 2, and so on). For example, the optimal signaling assignment for ideal selection verification is 84265137, which means that the codeword 111 is used to signal transmit antenna 1, 010 signal transmit antenna 2, and so on. The signaling assignments, which were found to be the best for ideal selection verification and no-selection verification are denoted by μᵥₑᵣ* and μₙₒ₋ᵥₑᵣ*, respectively. The signaling assignments are listed in Table I(a).

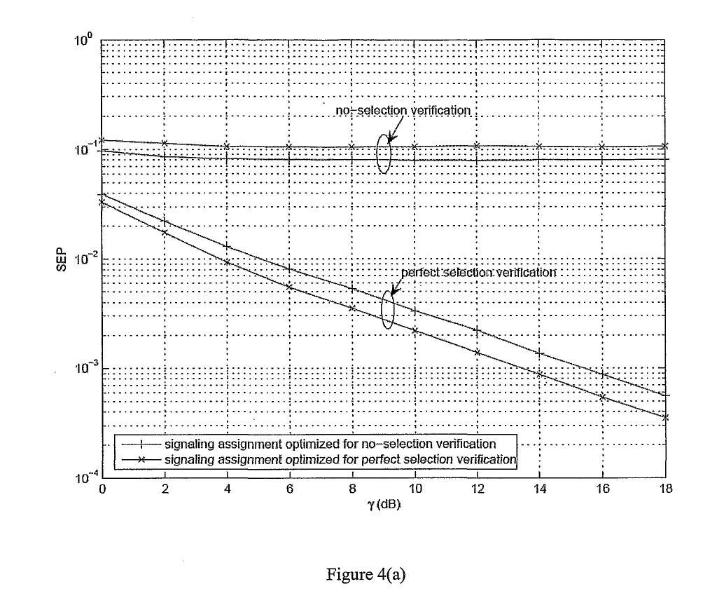

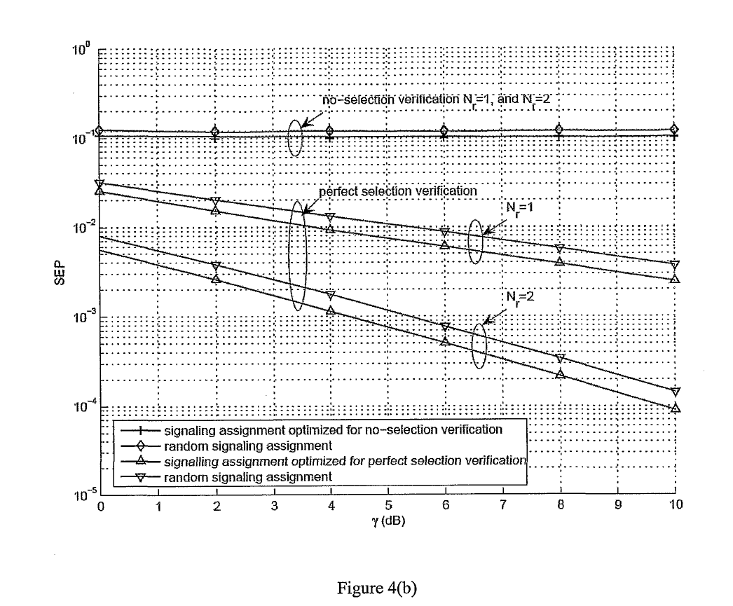

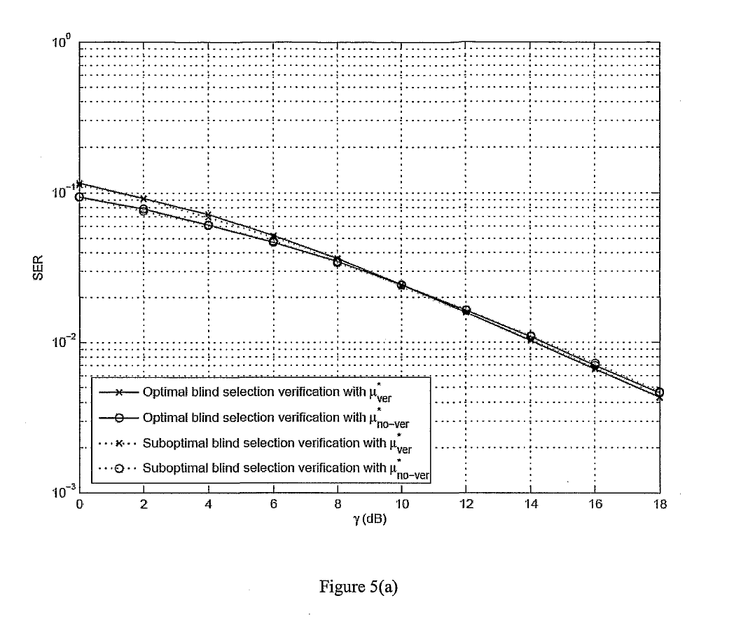

FIG. 4(a) compares the SEP performance of μᵥₑᵣ* and μₙₒ₋ᵥₑᵣ*. It can be seen that no-selection verification exhibits an error floor that is of the order of nε, while the ideal selection verification does not suffer from such a floor. Optimal signaling assignments lead to a lower error floor for no-selection verification and a 1.5 to 2 dB improvement in SNR for ideal selection verification.

It is interesting to note that the signaling assignment, μᵥₑᵣ*, optimized for ideal selection verification, performs poorly when used with no-selection verification. The same conclusion also applies to the case when μₙₒ₋ᵥₑᵣ*, which is optimized for no-selection verification, is used with ideal selection verification.

For Nₜ=16 and Lₜ=1, the total number of signaling assignments increases to 16!=2.0923e+013, which is well beyond the brute-force search capabilities of many computers. For Nₜ=16 the BSA was run for 100 randomly chosen initial signaling assignments. Table I(b) lists the best signaling assignments, along with two randomly chosen ones, for Nₜ=16. FIG. 4(b) compares the performance of the different signaling assignments for different number of receive antennas for Nₜ=16. The performance gain of the optimal signaling assignment can be seen clearly in all cases. It is also noted that the optimal signaling assignment is independent of the number of receive antennas in the system.

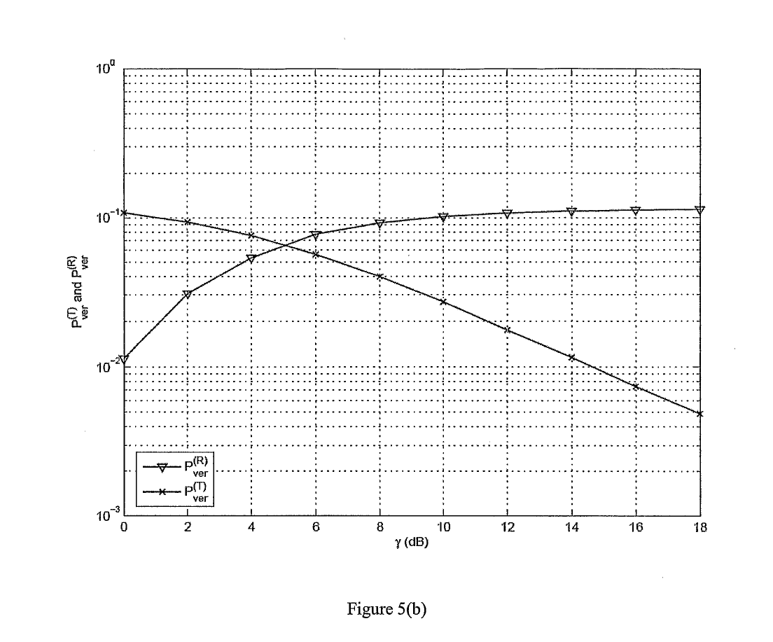

FIG. 5(a) compares the SEP performance of the blind optimal symbol-level selection verification receiver (line) and the blind sub-optimal symbol-level selection verification receiver (dot) for the two signaling assignments μᵥₑᵣ* and μₙₒ₋ᵥₑᵣ*. It can be seen that there is no difference in SEP performance for these two receivers. For blind symbol-level selection verification, μₙₒ₋ᵥₑᵣ* works better at low SNR, while μᵥₑᵣ* works better at high SNR.

To clarify blind symbol-level selection verification, FIG. 5(b) plots Pᵥₑᵣ^{(T)} and Pᵥₑᵣ^{(R)} using the signaling assignment μᵥₑᵣ* . It can be seen that Pᵥₑᵣ^{(T)} decreases as the SNR increases and is always below the feedback codeword error probability, which approximately equals ε log₂(Nₜ) for ε<<1. This implies that the performance of the selection verification algorithm improves with the SNR. On the other hand, Pᵥₑᵣ^{(R)} increases with the SNR. This is because at low SNR, when blind selection verification is difficult, the optimal estimate of the transmit antenna is often the one requested by the receiver. On the other hand, at high SNR, when the receiver can accurately determine which transmit antenna was used, Pᵥₑᵣ^{(R)} reduces to the probability that s′≠s, which equals εlog₂(Nₜ). Therefore, blind sub-optimal selection verification behaves like no-selection verification at low SNR and as ideal selection verification at high SNR. Given that the signaling assignment optimized for one receiver is ill-suited for the other, as was observed earlier, the crossing of the average SEP curves for the two signaling assignments is to be expected. Thus, for the blind selection verification, the optimization of the signaling assignment is not independent of γ.

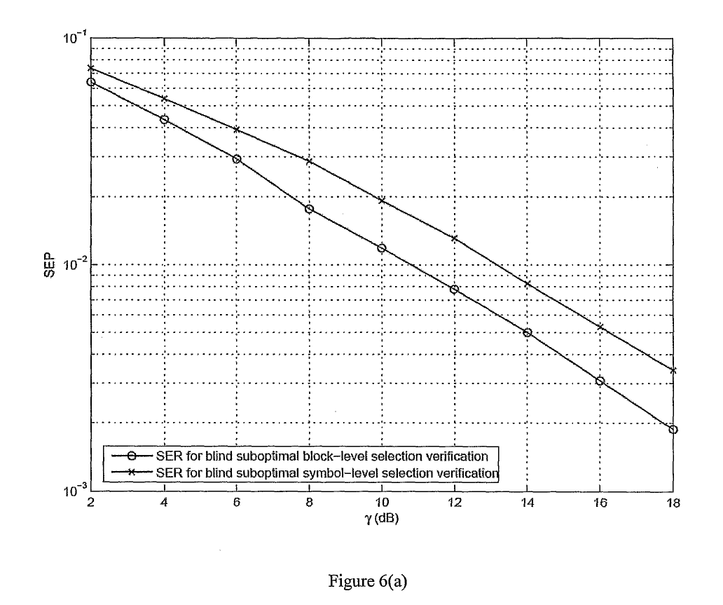

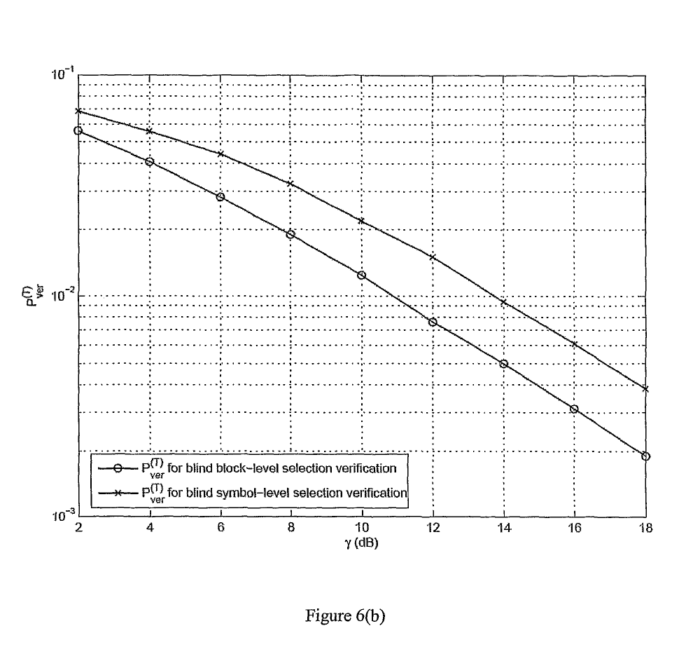

FIG. 6 compares the average SEP and Pᵥₑᵣ^{(T)} of symbol-level and block-level selection verification for Nₜ=4, Lₜ=1, Nᵣ=1, and a block-fading length K=2. It can be seen that blind block-level selection verification requires 3 dB lower SNR than the blind symbol-level verification for the same Pᵥₑᵣ^{(T)}. This also results in a 3 dB gain in the average SEP curves.

Previous figures showed that blind selection verification, even if optimal, has decreased performance compared to ideal selection verification. Side information is one way of improving performance.

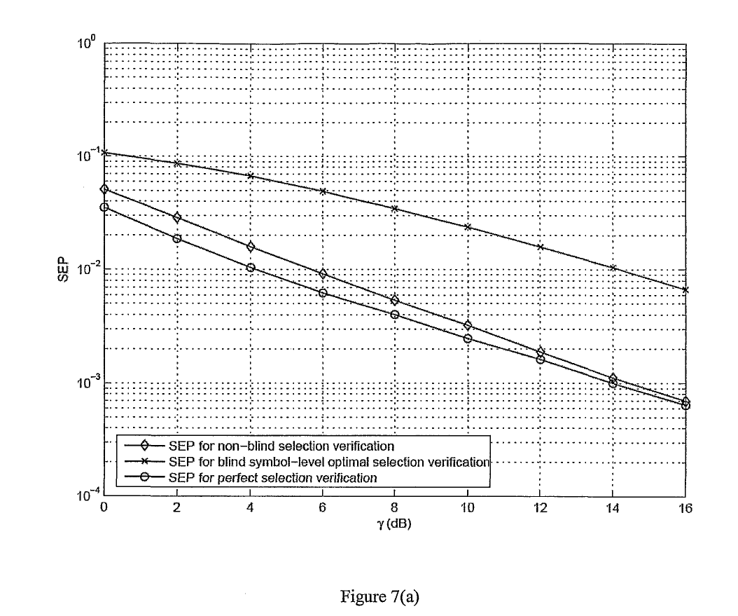

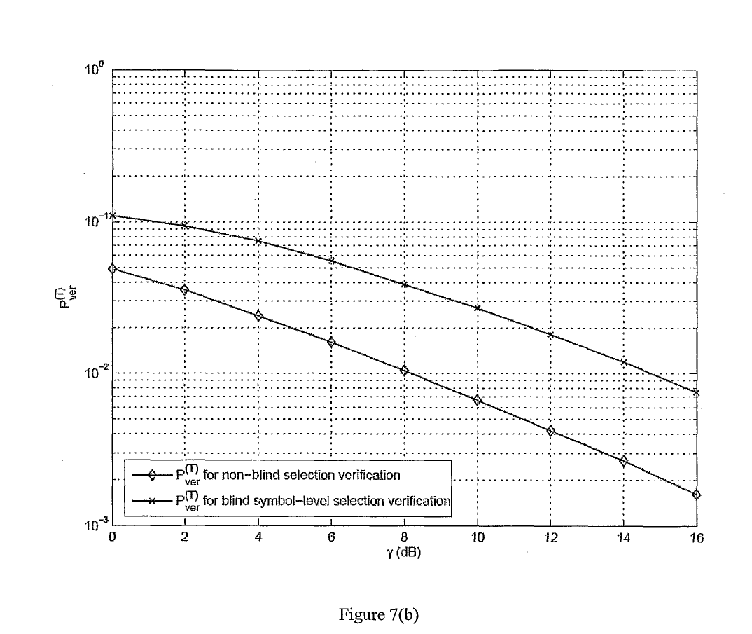

FIG. 7 compares the SEP and Pᵥₑᵣ^{(T)} of non-blind optimal selection verification with ideal selection verification and no-selection verification for Nₜ=8, Lₜ=1, and Nᵣ=1. The block-fading duration is K=21. It consists of Kₚ=1 pilot symbols followed by 20 data symbols, with the same transmit power used for both pilot and data. It can be seen that even with a small 5% pilot symbol overhead, non-blind selection verification comes close to ideal selection verification. For this reason, the signaling assignment optimal for ideal selection verification, μᵥₑᵣ*, is used throughout.

### Optimal Side Information Overhead:

As a non-limiting alternative, more symbols or more energy can be allocated to the pilot to improve the selection verification accuracy. However, increasing the number of pilot symbols reduces the transmission time for data and reduces the net transmission rate. Equivalently, for a fixed total energy budget and a fixed number of pilot symbols, increasing the energy allocated to pilots reduces the energy available for data transmission and increases the SEP.

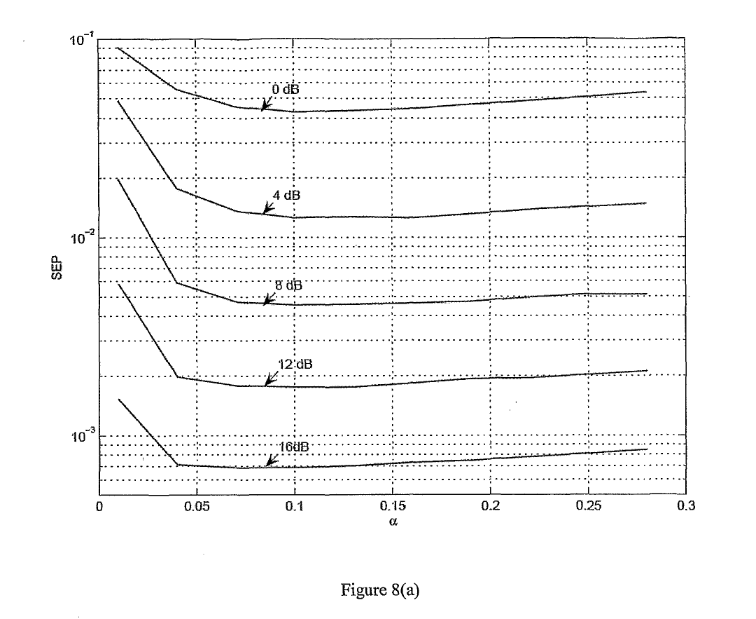

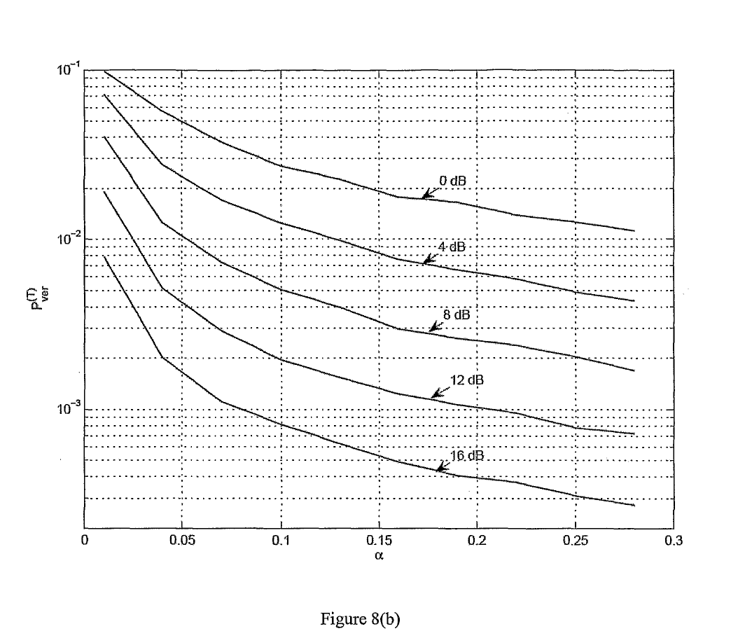

FIG. 8 compares this trade-off between side-information overhead and selection verification accuracy. The SEP with non-blind antenna selection verification is plotted for different α and at different SNR. The parameters assumed are Nₜ=8, Lₜ=1, and Nᵣ=1, with K=21 and Kₚ=1. As before, the signaling assignment μᵥₑᵣ* is used. The conclusion is that an optimal trade-off does exist, and the optimal value of the side information overhead, α, is insensitive to the SNR.

The previous examples considered the case where the number of possible bit sequences equals the number of available transmit antenna sets. The following non-limiting examples consider the coded feedback case, where more bit sequences than the required number of codewords are available.

In the following non-limiting example, more bit sequences are available than the required number of codewords. The first case is one in which the bit sequences are codewords of length n bits of an error correction code as described in J. G. Proakis, Digital Communications, McGraw-Hill, 2nd ed., 1989, S. Lin and D. J. Costello, Error Control Coding, Prentice Hall, 2 ed., 2004, the contents of which are herein incorporated by reference. In this case, the invention described herein can be applied as follows. The codeword error probability formula, Φ, changes from the one given in (4) to the corresponding codeword error probability for the error correction code being used. Therefore, formulae for the metrics in (20) and (27) will use the code-specific formula for Φ. The formulae for selection verification in (34), (35), (36), (37), and (41) will also use the code-specific formula for Φ. Given that it is difficult to determine this probability, in closed-form, for many codes, approximations such as the union bound approximation may also be used as described by J. G. Proakis, Digital Communications, McGraw-Hill, 2nd ed., 1989, S. Lin and D. J. Costello, Error Control Coding, Prentice Hall, 2 ed., 2004.

The most general formulation of the problem is the following. Let L denote the cardinality of S, which is the total number of transmit antenna choices. Let the feedback codewords use n bits. Therefore, the total number of possible bit sequences is 2ₙ, of which L are codewords. The signaling assignment problem then needs to determine the L bit sequences, out of the possible 2ⁿ bit sequences, that will be used as codewords, and also determine the signaling assignment between the codewords and the transmit antenna choices. Therefore, the total number of possibilities is (2_{L}^{N})L!.

We now describe a virtual antenna technique to determine the optimal signaling assignment. Let L=2^{k}. For each transmit antenna choice, we first create 2^{n-k} virtual antennas. All these 2^{n-k} virtual antennas are co-located at the location of the “real” transmit antenna choice. There are now 2ₙ, virtual antenna selections.

The optimization can be done in two steps. In the first step, 2ⁿ×2ⁿ virtual correlation matrix is created, R̅, which is given by:

R̅=\tilde{R}\textcircled{X}1₂ₙ₋ₖ (42)

where \textcircled{X} is the Kronecker product, and 1₂ₙ₋ₖ is an all-one matrix of size 2^{n-k}×2^{n-k}. The correlation between two virtual choices is just the corresponding element in the virtual correlation matrix, R̅.

With this correlation matrix, the metrics and BSA described above can be applied to find optimal signaling assignment from the virtual antenna set to the set of all bit sequences. This step results in 2^{n-k} bit sequences being assigned to each “real” transmit antenna choice.

The second step of optimization determines, for each real transmit antenna choice, which codeword from the from the 2^{n-k} bit sequences is to be used for feedback. This can be done either by choosing them randomly or by means of a brute-force search over the 2n−k codewords.

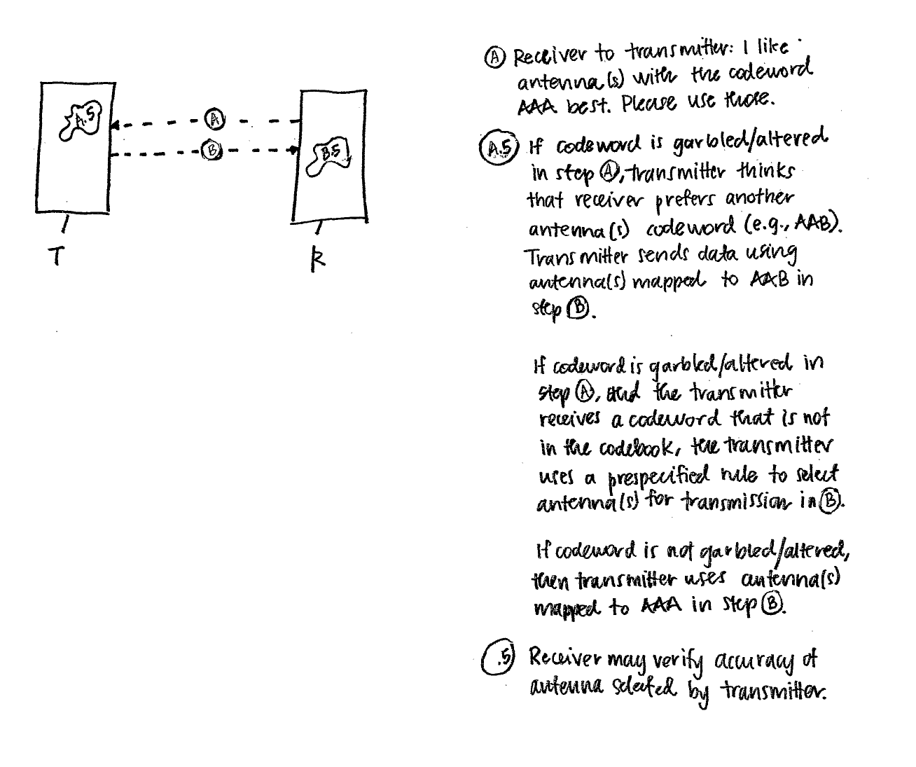

FIGS. 12 and 13 illustrate non-limiting examples of the implementation of the method and system of the present invention. To this end, FIG. 12 illustrates communications between the transmitter and the receiver, including system initiation and update communications. FIG. 13 illustrates communications between the transmitter and the receiver, excluding system initiation and update communications.

The present invention includes processing of transmitted and received signals, and programs by which the received signals are processed. Such programs are typically stored and executed by a processor in a wireless receiver implemented in VLSI. The processor typically includes a computer program product for holding instructions programmed and for containing data structures, tables, records, or other data. Examples are computer readable media such as compact discs, hard disks, floppy disks, tape, magneto-optical disks, PROMs (EPROM, EEPROM, flash EPROM), DRAM, SRAM, SDRAM, or any other magnetic medium, or any other medium from which a processor can read.

The computer program product of the invention may include one or a combination of computer readable media to store software employing computer code devices for controlling the processor. The computer code devices may be any interpretable or executable code mechanism, including but not limited to scripts, interpretable programs, dynamic link libraries (DLLs), Java classes, and complete executable programs. Moreover, parts of the processing may be distributed for better performance, reliability, and/or cost.

While the invention has been described with reference to exemplary embodiments thereof, it is to be understood that the invention is not limited to the exemplary embodiments in any way and that the invention is intended to cover all the various modifications and equivalent steps which one of ordinary skill in the art would appreciate upon reading this specification.

Numerous modifications and variations of the present invention are possible in light of the above teachings. It is therefore to be understood that within the scope of the appended claims, the invention may be practiced otherwise than as specifically described herein.

1. A method for receiving data at a receiver via a communication channel from a transmitter having at least two transmitter antennas, the method comprising:
receiving a codebook including an assignment of at least two respective codewords to the at least two transmitter antennas, the assignment being based at least in part on a characteristic of the communication channel;
detecting a state of the communication channel by which the receiver can communicate with the transmitter;
selecting at least one desired transmitter antenna from the at least two antennas based at least in part on the detected state of the communication channel;
transmitting to the transmitter a message including a codeword corresponding to the selected at least one desired transmitter antenna; and
receiving at the receiver data transmitted from the transmitter using at least one transmitting antenna selected at the transmitter in response to reception at the transmitter of the message including a codeword transmitted from the receiver.

2. The method according to claim 1, further comprising:
verifying that the transmitter transmitted the data using the at least one desired transmitter antenna.

3. The method according to claim 2, wherein the verifying is based at least in part on identification information provided by the transmitter.

4. The method according to claim 2, wherein the verifying includes at least one of using a pilot signal provided in the data, using identification information provided by the transmitter on a different communication channel, and approximating based at least in part upon communication channel information available at the receiver.

5. The method according to claim 1, wherein the selecting comprises selecting the at least one desired transmitter antenna based at least in part on a likelihood of a codeword error.

6. The method according to claim 1, wherein the selecting comprises selecting the at least one desired transmitter antenna based at least in part on a detected signal to noise ratio of the communication channel.

7. The method according to claim 1, wherein the transmitting data comprises transmitting data using the at least one transmitting antenna that includes a subset of at least two antennas.

8. The method according to claim 1, wherein the receiving includes receiving a codebook in which the assignment is based at least in part on a signal to noise ratio of the communication channel, a likelihood of a codeword error, or a correlation between a first antenna element of the at least two transmitter antennas and a second antenna element of the at least two transmitter antennas.

9. The method according to claim 1, wherein the receiving data includes receiving data from the at least one transmitting antenna that is different from the at least one desired transmitter antenna.

10. The method according to claim 1, wherein the at least two codewords include first and second respective bit sequences, and the at least two codewords have values assigned based at least in part on a Hamming distance between the first bit sequence and the second bit sequence and at least in part on a determined correlation between the at least two transmitter antennas.

11. The method according to claim 1, wherein the assignment of the at least two codewords is based at least in part on a binary switching algorithm or on an algorithm developed for a quadratic assignment problem.

12. The method according to claim 1, wherein selecting the at least one desired antenna includes selecting the at least one desired transmitter antenna including a subset of at least two antennas.

13. A method performed in a system in which a transmitter transmits data to a receiver using at least one of at least two transmitter antennas and a communication channel, the method comprising:
determining a correlation between a first antenna element of the at least two transmitter antennas, which is assigned a first codeword, and a second antenna element of the at least two transmitter antennas; and
assigning a second codeword to the second antenna element based at least in part on a Hamming distance between a first bit sequence representing the first codeword and a second bit sequence representing the second codeword and at least in part on the determined correlation.

14. The method according to claim 13, wherein the assigning further comprises assigning the at least one second codeword based at least in part on a detected signal to noise ratio of the communication channel.

15. The method according to claim 13, wherein the assignment of the at least two codewords is based at least in part on a binary switching algorithm or on an algorithm developed for a quadratic assignment problem.

16. A method for transmitting data in a system in which a transmitter having at least two transmitter antennas transmits data to a receiver via a communication channel using at least one of the at least two antennas, the method comprising:
transmitting to a receiver a codebook which includes an assignment of at least two respective codewords to at least two of the at least two transmitter antennas, the assignment being based at least in part on a characteristic of the communication channel;
receiving at the transmitter a message including a codeword corresponding to at least one desired transmitter antenna;
selecting at the transmitter at least one transmitting antenna in response to reception at the transmitter of the message including a codeword transmitted from the receiver; and
transmitting data to the receiver using the at least one transmitting antenna.

17. The method according to claim 16, further comprising transmitting identification information to the receiver which indicates the at least one transmitting antenna.

18. The method according to claim 17, wherein the transmitting identification information includes at least one of transmitting a pilot signal at least partially identifying the at least one transmitting antenna or transmitting identification information to the receiver using a different communication channel.

19. The method according to claim 16, wherein the receiving comprises receiving a codeword selected based at least in part on a likelihood of a codeword error.

20. The method according to claim 16, wherein the receiving comprises receiving a codeword selected based at least in part on a detected signal to noise ratio of the communication channel.

21. The method according to claim 16, wherein the transmitting data comprises transmitting data using at least one transmitting antenna that includes a subset of at least two antennas.

22. The method according to claim 16, wherein the transmitting data comprises transmitting data using at least one transmitting antenna that is different from the at least one desired transmitter antenna.

23. The method according to claim 16, wherein the assignment of the at least two codewords is based at least in part on a binary switching algorithm or on an algorithm developed for a quadratic assignment problem.

24. The method according to claim 16, wherein selecting the at least one desired antenna includes selecting the at least one desired transmitter antenna including a subset of at least two antennas.

25. A system in which a transmitter having at least two transmitter antennas transmits data to a receiver via a communication channel using at least one of the at least two transmitter antennas, the system comprising:
the transmitter configured to transmit a codebook which includes an assignment of at least two respective codewords to at least two of the at least two transmitter antennas, the assignment being based at least in part on a characteristic of the communication channel;
the receiver configured to receive the codebook, to select a codeword corresponding to at least one desired transmitter antenna, and to transmit a message including the selected codeword to the transmitter; and
the transmitter further configured to transmit data to the receiver using at least one transmitting antenna selected at the transmitter in response to reception at the transmitter of the message including a codeword transmitted from the receiver.

26. The system according to claim 25, wherein the receiver is further configured to verify that the transmitter transmitted the data using the at least one desired transmitter antenna corresponding to the selected codeword.

27. The system according to claim 26, wherein the receiver is configured to verify that the transmitter transmitted the data using the at least one desired transmitter antenna using at least one of a pilot signal provided in the data, identification information provided by the transmitter on a different communication channel, or available communication channel information.

28. The system according to claim 25, wherein the receiver is configured to select the at least one desired transmitter antenna based at least in part on a likelihood of a codeword error.

29. The system according to claim 25, wherein the at least one characteristic includes a signal to noise ratio.

30. The system according to claim 25, wherein the at least one desired transmitter antenna corresponding to the selected codeword includes a subset of at least two antennas.

31. The system according to claim 25, wherein the at least one transmitting antenna is different from the at least one desired transmitter antenna.

32. The system according to claim 25, wherein the assignment of the at least two codewords is based at least in part on a binary switching algorithm or on an algorithm developed for a quadratic assignment problem.

33. The system according to claim 25, wherein the at least one desired antenna includes a subset of at least two antennas.

34. A computer program product storing a computer program which when executed by a processor in a radio network causes the processor to perform steps of:
receiving a codebook including an assignment of at least two respective codewords to at least two transmitter antennas, the assignment being based at least in part on a characteristic of a communication channel;
detecting a state of the communication channel by which a receiver can communicate with the transmitter;
selecting at least one desired transmitter antenna from the at least two antennas based at least in part on the detected state of the communication channel;
transmitting to the transmitter a message including a codeword corresponding to the selected at least one desired transmitter antenna; and
receiving at the receiver data transmitted from the transmitter using at least one transmitting antenna selected at the transmitter in response to reception at the transmitter of the message including a codeword transmitted from the receiver.

35. A computer program product storing a computer program which when executed by a processor in a radio network causes the processor to perform steps of:
determining a correlation between a first antenna element of at least two transmitter antennas, which is assigned a first codeword, and a second antenna element of the at least two transmitter antennas; and
assigning a second codeword to the second antenna element based at least in part on a Hamming distance between a first bit sequence representing the first codeword and a second bit sequence representing the second codeword and at least in part on the determined correlation.

36. A computer program product storing a computer program which when executed by a processor in a radio network causes the processor to perform steps of:
transmitting to a receiver a codebook which includes an assignment of at least two respective codewords to at least two transmitter antennas, the assignment being based at least in part on a characteristic of the communication channel;
receiving at the transmitter a message including a codeword corresponding to at least one desired transmitter antenna;
selecting at the transmitter at least one transmitting antenna in response to reception at the transmitter of the message including a codeword transmitted from the receiver; and
transmitting data to the receiver using the at least one transmitting antenna.
